(19) United States
(12) Patent Application Publication
(10) Pub. No.: US 2023/0408042 A1
(43) Pub. Date: Dec. 21, 2023

(54) MODULAR PRESSURIZED GAS TANK

(71) Applicant: FAURECIA SYSTEMES D'ECHAPPEMENT, Nanterre (FR)

(72) Inventor: Ronan BOTELLA, CHEVREMONT (FR)

(21) Appl. No.: 18/208,385

(22) Filed: Jun. 12, 2023

(30) Foreign Application Priority Data
Jun. 17, 2022 (FR) 22 05950

(51) Int. Cl. F17C 13/08

(52) U.S. Cl. CPC F17C 13/084; F17C 2205/0138; F17C 2205/0142; F17C 2201/0104

(57) ABSTRACT

A modular tank is provided for storing pressurized gas, such as hydrogen. The modular tank comprises at least two substantially cylindrical cylinders that are arranged parallel side by side, and are fluidly connected to one another by at least one tube. The at least one tube is arranged in a space between the at least two cylindrical cylinders.

### CROSS-REFERENCE TO RELATED APPLICATION

This application is a U.S. non-provisional application claiming the benefit of French Application No. 22 05950, filed on Jun. 17, 2022, which is incorporated herein by reference in its entirety.

### TECHNICAL FIELD

The disclosure relates to a modular or multi-element tank capable of accommodating pressurized gas, such as hydrogen.

### BACKGROUND

It is known to store gas under pressure, in a substantially parallelepipedal volume, to produce a modular or multi-element tank. Such a tank comprises a plurality of elements, such as cylinders. These cylinders are substantially identical.

In order to withstand the very high envisaged pressures, up to 1050 bars, the cylinders have a substantially cylindrical shape with a circular section.

The cylinders are arranged in parallel; their axes are parallel. They are also arranged side by side; they are adjacent and their generatrixes are in contact.

The parallelepiped volume has a depth equal to the diameter of a cylinder, a width equal to the length of a cylinder and a length equal to the diameter of a cylinders multiplied by the number of cylinders.

Due to the use of circular-section cylinders, the storage volume is not optimized. A filled parallelepipedal volume/storage volume ratio appears that corresponds to the ratio of a circle over a square with a side equal to the diameter of said circle, i.e. a ratio of π/4≈78%, further decreased by the thicknesses of the walls of the cylinders.

### SUMMARY

The disclosure improves on this ratio by using spaces left free between the cylinders.

A modular tank is provided for storing pressurized gas, such as hydrogen. The modular tank comprises at least two substantially cylindrical cylinders that are arranged parallel to side by side, and are fluidly connected to one another by at least one tube. The at least one tube is arranged in a space between said at least two cylindrical cylinders.

Particular features or embodiments, usable alone or in combination, are:
a space is delimited by two adjacent cylinders and by a plane tangent to the two adjacent cylinders,
each of said spaces accommodates a tube with a diameter of less than or preferably equal to one quarter of the diameter of a cylinder,
the tube of the first space is connected, to the first cylinder via its first end and to the tube of the second space via its second end, and the tube of the second space is connected to the tube of the first space by its first end and to the second cylinder via its second end,
each of said spaces accommodates three tubes with a diameter of less than or preferably equal to (2/(√3)−1) times the diameter of a cylinder,
the three tubes of the first space are connected to one another in series, the three tubes of the second space are connected together in series and with the three tubes of the first space in series,
the cylinders are connected, via the tubes, in series,
the cylinders are connected, via the tubes, in parallel,
said at least one cylinder is of type IV, comprising a composite structure and an internal sealing envelope,
said at least one tube is metallic,
said at least one tube is of type IV.

### BRIEF DESCRIPTION OF THE DRAWINGS

The disclosure will be better understood on reading the following description, given solely by way of example, and with reference to the appended figures in which:

FIG. 1 shows, in a three-view plane, a bottom view, a side view, and a top view of a tank;

FIG. 2 shows, in a sectional view, a tank with a tube;

FIG. 3 shows, in a sectional view, a tank with three tubes;

FIG. 4 shows, in schematic view, a connection of the cylinders in parallel, with a tube;

FIG. 5 shows, in schematic view, a connection of the cylinders in parallel, with three tubes;

FIG. 6 shows, in schematic view, a connection of the cylinders in series, with one tube; and

FIG. 7 shows, in schematic view, a connection of the cylinders in series, with three tubes.

### DETAILED DESCRIPTION

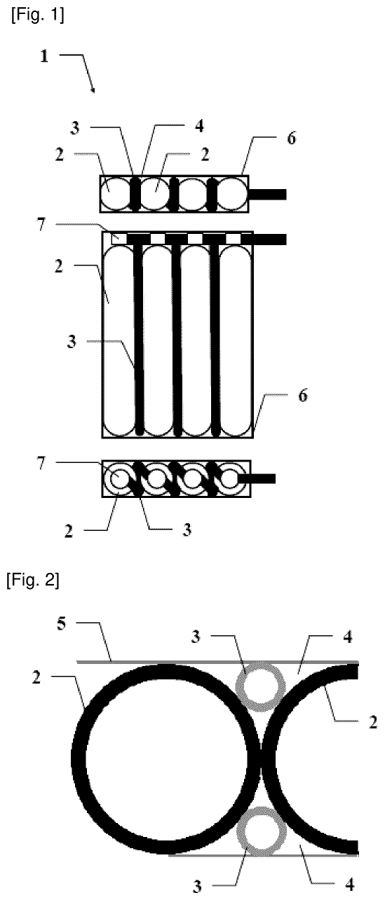

With reference to FIG. 1, the disclosure relates to a modular tank 1 more particularly dedicated to the storage of pressurized gas, such as hydrogen. The modularity is obtained by joining multiple elements, such as cylinders 2. The modularity makes it possible to vary the volume of the tank at will by adding, as needed, elements. A typical application of such a tank is the storage of hydrogen on a vehicle for the purposes of propulsion.

In order to provide for and facilitate its integration on the vehicle, the tank substantially occupies the shape of a parallelepiped, which can advantageously be embodied by a parallelepipedal housing 6 enveloping the elements and their accessories.

The tank 1 is constituted by juxtaposing the cylinders 2. These cylinders 2 are at least two in number. Their maximum number depends on the desired storage capacity. The cylinders 2 are substantially identical. They are substantially cylindrical, and arranged parallel side by side. It is also possible to have more than one row of cylinders 2. They are advantageously fluidly connected to one another in order to provide an overall storage capacity via at least one tube 3.

According to a feature of the disclosure, this at least one tube 3 is fluidically connected to at least one of said at least two cylinders 2 so as to increase, by its enveloped volume, the storage capacity of the tank 1.

The main loss of volume useful for storage, from the parallelepipedal volume, is constituted by the two spaces 4, left free between two adjacent cylinders 2.

One way of taking advantage of this free volume is to arrange at least one tube 3 in one, the other, or preferably both spaces 4. A space 4 is delimited by two adjacent cylinders 2 and by a plane 5 tangent to the two adjacent cylinders 2. A space 4 then has a cylindrical shape, of substantially triangular section, with two sides of the triangle in the concave arc of a circle.

According to another feature, more particularly illustrated in FIG. 2, a tube 3 is arranged in a space 4, and preferentially a tube 3 in both of the two spaces 4. In order to optimize the volume capacity, this single tube 3 is of a maximum diameter dl allowed by the space 4, or an outer tube diameter dl of tube 3 at most equal to one quarter or 0.25 times the outer diameter d of a cylinder 2. Such a tube 3 is then in contact with the two adjacent cylinders 2 and tangent to the plane 5 that is tangent to the two cylinders 2.

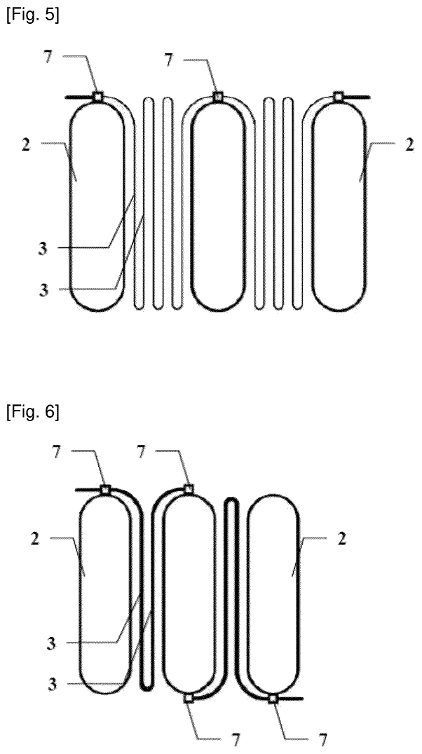

According to another feature, the first tube 3, arranged in the first space 4 has its first end connected, to the first cylinder 2, typically via its valve 7, and its second end connected to the second tube 3, arranged in the second space 4. Likewise, the second tube 3, arranged in the second space 4 has its first end connected to the first tube 3 and its second end connected to the second cylinder 2, typically via its valve 7. This is more particularly illustrated in FIGS. 4 and 6.

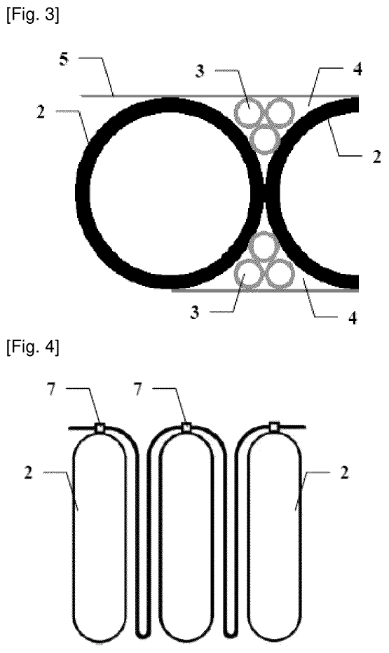

According to another feature, more particularly illustrated in FIG. 3, three tubes 3 are arranged in a space 4, and preferentially three tubes 3 in both of the two spaces 4. In order to optimize the volume capacity, these three tubes 3 have a diameter d3, preferably identical for the three tubes 3, the maximum allowed by the space 4, or an outer tube diameter d3 of tube 3 at most equal to (2/(√3)−1), i.e. approximately 0.15 times the outer diameter D of a cylinder 2. Such a trio of tubes 3 is then such that the three tubes 3 are in contact with each other, that the trio is in contact with the two adjacent cylinders 2 and is tangent to the plane 5 tangent to the two cylinders 2.

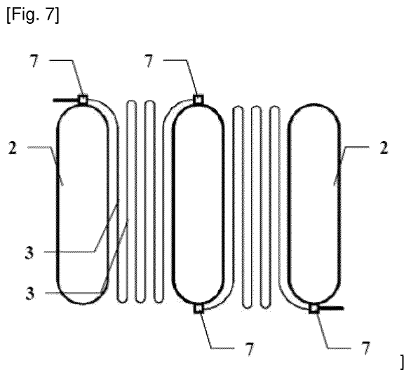

According to another feature, the three tubes 3 of the first space 4 are connected to one another in series. Likewise, the three tubes 3 of the second space 4 are connected together in series. Furthermore, the three tubes 3 of the second space 4 are also connected with the three tubes 3 of the first space 4 in series. This is more particularly illustrated in FIGS. 5 and 7.

It is also possible to increase the number of tubes 3 beyond three. However, such a configuration does not appear to provide many advantages.

The increase in the number of tubes 3 compromises an increase in the total mass. Furthermore, as the number of tubes 3 increases, a reduction in the passage section appears, making the filling/emptying of the tank 1 more difficult.

The version with three tubes 3 is slightly more advantageous with a ratio of useful volume (volume available to store gas) to total volume (volume of the circumscribed parallelepiped), slightly more favorable at 62% compared to 61% for the version with one tube 3. However, the version with three tubes 3 has a mass greater than the version with one tube.

According to another feature, the cylinders 2 are connected, via the tubes 3, in series. This is more particularly illustrated in FIGS. 6 and 7. Such a configuration requires each cylinder 2 to comprise a valve 7 at each end.

According to another feature, the cylinders 2 are connected, via the tubes 3, in parallel. This is more particularly illustrated in FIGS. 4 and 5.

A connection of two cylinders 2, via one or three pairs of tubes 3, advantageously connected in series, is advantageous in that it constitutes between the respective valves 7 of the two cylinders 2, a pipe formed of tubes 3 mounted “accordion-style”. This is particularly advantageous in the event of an input load to the tank 1, for example following an impact of the vehicle carrying the tank 1. Indeed, in the event of separation of the cylinders 2, one of the other, the accordion pipe forms a deformable element, which reduces the forces on the respective valves 7 of the cylinders 2 and thus reduces the possibility of a valve 7 tearing.

A cylinder 2 can be made of any material. Thus, in a conventional manner, it can be made of a metal material, such as, for example, a stainless steel. However, in order to reduce the weight balance, it can advantageously be made of plastic composite material.

Thus, according to another feature, said at least one cylinder 2 is of type IV. This means that a cylinder 2 is made around a composite structure that provides the structure and the shape. This structure is hollow. It comprises on its inner surface an internal sealing envelope or liner, ensuring the sealing of the gas.

Likewise, said at least one tube 3 may be made of any material.

According to another feature, said at least one tube 3 is metallic.

According to another feature, said at least one tube 3 is of type IV, as defined previously.

The disclosure has been illustrated and described in detail in the drawings and the preceding description. This must be considered illustrative and given by way of example and not as limiting the disclosure to this description alone. Many alternative embodiments are possible. The scope of the protection sought is defined by the appended claims.

### LIST OF REFERENCE SIGNS

1: tank
2: cylinder
3: tube
4: space
5: tangent plane
6: housing
7: valve/OTV.

1. A modular tank for storing pressurized gas comprising:
at least two cylindrical cylinders, arranged parallel side by side, fluidly connected to one another by at least one tube; and
at least one space between said at least two cylindrical cylinders, said at least one tube being arranged in one of the at least one space.

2. The modular tank according to claim 1, wherein at least one of the at least one space is delimited by two adjacent cylinders of the at least two cylindrical cylinders and by a plane tangent to the two adjacent cylinders.

3. The modular tank according to claim 1, wherein each of the at least one space accommodates the at least one tube of a diameter less than or equal to one-quarter of a diameter of one of the at least two cylindrical cylinders.

4. The modular tank according to claim 3, wherein the at least one tube comprises at least a first tube and a second tube, and wherein the at least one space comprises at least a first space and a second space, and wherein the first tube of the first space and is connected to a first cylinder of the at least two cylindrical cylinders via a first end and is connected to the second tube of the second space via a second end, and the second tube of the second space is connected to the first tube of the first space by a first end and to a second cylinder of the at least two cylindrical cylinders via a second end.

5. The modular tank according to claim 1, wherein the at least one tube comprises a plurality of tubes, and wherein each of the at least one space accommodates three tubes of the plurality of tubes, each tube having a diameter less than or equal to
$$( \frac{2}{√ 3} - 1 )$$
times a diameter of one of the at least two cylindrical cylinders.

6. The modular tank according to claim 5, wherein the three tubes of a first space of the at least one space are connected to one another in series, the three tubes of a second space of the at least one space are connected together in series and with the three tubes of the first space in series.

7. The modular tank according to claim 1, wherein the at least two cylindrical cylinders are connected, via the at least one tube, in series.

8. The modular tank according to claim 1, wherein the at least two cylindrical cylinders are connected, via the at least one tube in parallel.

9. The modular tank according to claim 1, wherein at least one cylinder of the at least two cylindrical cylinders is of type IV, comprising a composite structure and an internal sealing envelope.

10. The modular tank according to claim 1, wherein said at least one tube is metallic.

11. The modular tank according to claim 1, wherein said at least one tube is of type IV.
